(19) United States
(12) Patent Application Publication
(10) Pub. No.: US 2007/0273662 A1
(43) Pub. Date: Nov. 29, 2007

(54) DISPLAY APPARATUS AND DISPLAY METHOD FOR A PORTABLE DEVICE

(75) Inventors: Wen-Chuan Lian, Shenzhen (CN); Hua-Dong Cheng, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/613,201

(22) Filed: Dec. 20, 2006

(30) Foreign Application Priority Data
May 26, 2006 (CN) 200610060788.0

(51) Int. Cl. G06F 3/041

(52) U.S. Cl. 345/173

(57) ABSTRACT

A display apparatus adapted for a portable device is provided. The display apparatus includes a storage unit, a primary display, a secondary display, a touch pad, and a processing unit. The primary display is in a larger size than that of the secondary display. The primary display is capable of displaying a virtual keyboard in a power off state. The touch pad is positioned on the primary display, and is capable of generating an operational signal in response to a touch operation on the virtual keyboard. The processing unit is configured for recognizing the operational signal from the touch pad and performing a corresponding control on the primary display and the secondary display. A related display method adapted for the portable device is also provided.

### BACKGROUND

1. Technical Field

The present invention relates to display apparatuses and display methods, and particularly to a display apparatus and display method adapted for portable devices such as mobile phones.

2. General Background

The development in electronic technologies has led to many different models of portable devices introduced into the electronics consumer market, products such as mobile phones, personal digital assistants (PDA), etc., readily satisfy a business requirement or a personal convenience requirement. Theses available portable devices not only allow displaying visual messages that include graphics and text data as well as a means to access and manipulate such messages, but also allow editing visual messages. Therefore, in order to display or edit these visual messages, each portable device generally provides a physical keyboard for performing displaying inputs or editing inputs.

The physical keyboard is generally consisted of multiple rows of physical keys. In order to benefit users carrying the portable device, the physical keys are designed to be quite small in size and are also arranged compactly together to reduce a total size of the physical keyboard, thus, reducing a volume of the portable device. As a result, the user may easily mis-enter information due to the small and compact keyboard.

On the other hand, since the physical keyboard takes up a certain space of the portable device, the remaining space for holding a display of the portable device is limited. Consequently, information outputted from the display is also limited, and is usually outputted with a large font size. As a result, the display is required to update information with a large size many times.

In addition, when the user enters information, the display is required to remain in a power on state so as to display corresponding information. Therefore, when adopting a relatively large display, the portable device consumes much power for supporting the large display when entering information.

What is needed, therefore, is a portable device that can easily and precisely enter information, and is also capable of displaying relatively more information. Furthermore, the portable device should also be capable of consuming relatively less power to display information entered.

### SUMMARY

A display apparatus adapted for a portable device is provided. The display apparatus has a storage unit, a primary display, a secondary display, a touch pad, and a processing unit. The storage unit is configured for storing information. The primary display is capable of displaying a virtual keyboard in a power off state, wherein the virtual keyboard includes keys for editing information and keys for displaying information. The touch pad is positioned on the primary display covering an area of the keys for editing information and an area of the keys for displaying information, and is configured for generating an operational signal in response to a touch operation on the virtual keyboard. The processing unit is configured for recognizing the operational signal from the touch pad and performing a corresponding control on the primary display and the secondary display.

When the operational signal is generated in response to a touch operation on the touch pad corresponding to the keys for editing information, the processing unit acts to display information corresponding to the operational signal on the secondary display. When the operational signal is generated in response to a touch operation on the touch pad corresponding to the keys for displaying information, the processing unit obtains the information stored in the storage unit and acts to display the information on the primary display. When the processing unit has not received the operational signal for a predetermined time period from the touch pad corresponding to the keys for displaying information, the processing acts to display the virtual keyboard on the primary display and acts to power off the primary display.

A display method adapted for the portable device is also provided, wherein the portable device has a primary display, a secondary display, a storage unit, and a touch pad positioned on the primary display. The method includes the steps of: (a) displaying a virtual keyboard on the primary display when the primary display is in a power off state, wherein the virtual keyboard includes key for editing information, and keys for displaying information; (b) generating an operational signal in response to a touch operation on the virtual keyboard; (c) displaying information corresponding to the operational signal on the secondary display, if the operational signal is generated in response to the touch operation on the touch pad corresponding to the keys for editing information of the virtual keyboard; (d) displaying information stored in the storage unit on the primary display, if the operational signal is generated in response to the touch pad corresponding to the keys for displaying information of the virtual keyboard; and (e) displaying the virtual keyboard on the primary display and powering off the primary display, if a duration of not receiving the operational signal from the touch pad corresponding to the keys for displaying information exceeds a predetermined time period.

Other advantages and novel features will be drawn from the following detailed description with reference to the attached drawing, in which:

### BRIEF DESCRIPTION OF THE DRAWINGS

FIG. 1 is a schematic diagram of a hardware infrastructure of a display apparatus of a portable device in accordance with a preferred embodiment of the present invention;

FIG. 2 is a schematic diagram showing a stand-by state of the display apparatus of FIG. 1; and

FIG. 3 is a flowchart of a preferred display method of the display apparatus of FIG. 1.

### DETAILED DESCRIPTION OF THE EMBODIMENT

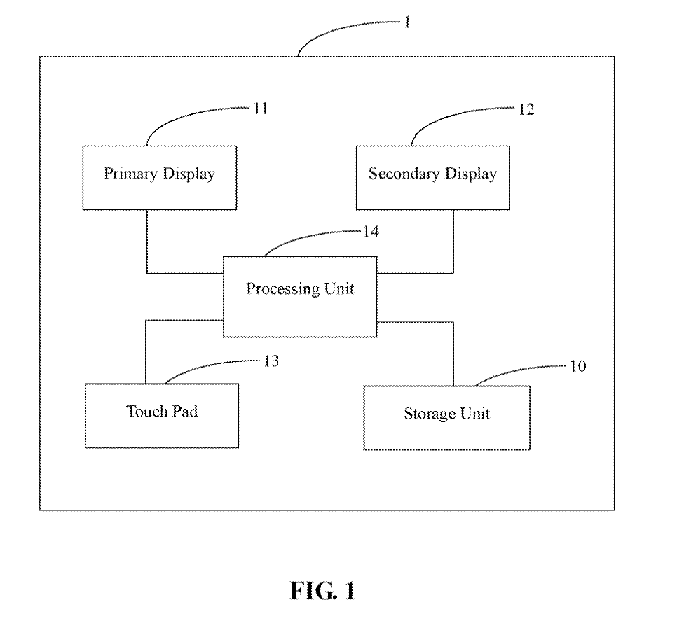

FIG. 1 is a schematic diagram of a hardware infrastructure of a display apparatus in accordance with a preferred embodiment of the present invention. The display apparatus 1 is adapted for portable devices, such as mobile phones, personal digital assistants, and the like. The display apparatus 1 includes a storage unit 10, a primary display 11, a secondary display 12, a touch pad 13, and a processing unit 14. The storage unit 10 is configured for storing information. The touch pad 13 is positioned on the primary display 11, and is configured for generating operational signals, for example editing inputs, viewing inputs, etc., in response to user operations (e.g., touch).

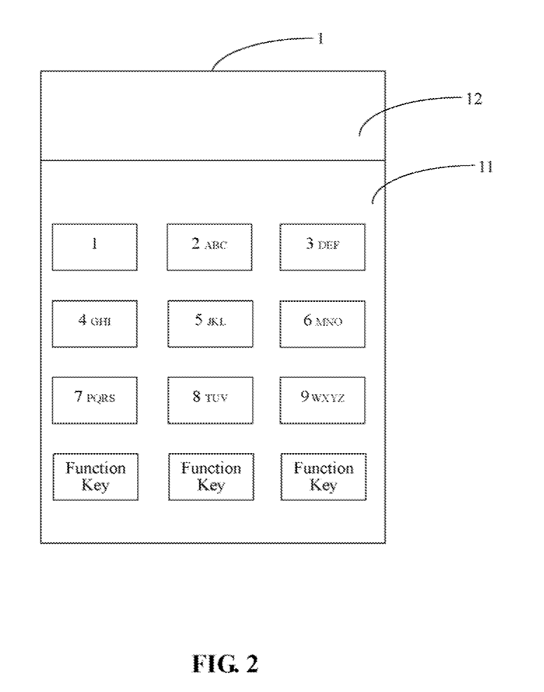

The primary display 11 is preferably a non-volatile display such as an E-Ink (Electronic Ink) display, whereas the secondary display 12 is preferably a volatile display such as a TFT LCD (Thin Film Transistor Liquid Crystal Display). Therefore, the primary display 11 is capable of displaying information when a state of the primary display 11 is in a powered off state. Furthermore, the primary display 11 and the secondary display 12 are on the same side of the portable device as that shown in FIG. 2. In addition, the primary display 11 is relatively larger than the secondary display 12 in size, thereby displaying more information than that of the secondary display 12.

The processing unit 14 is configured for controlling the components of the display apparatus 1 such as, for example, the storage unit 10, the primary display 11, the secondary display 12, and the touch pad 13.

When a state of the portable device is a stand-by state, the processing unit 14 acts to display a virtual keyboard on the primary display 11 and controls the state of the primary display 11 and a state of the secondary display 12 to be in a power off state. The virtual keyboard includes a plurality of keys. Each of the keys can take a form of a geometrical shape such as a square, a rectangle, a triangle, a circle, an ellipse, or any desired geometrical shape at a designer's choice. For example, in the embodiment shown in FIG. 2, the keys are in the form of a rectangle. Furthermore, the keys can be the same, shape-wise or size-wise, or different from each other. For example, in the embodiment shown in FIG. 2, the keys are in the same sizes. In addition, the keys include alphanumeric keys and function keys. The function keys include keys relating to displaying information. The number of either the alphanumeric keys or the function keys and the arrangement of the alphanumeric keys and the function keys are not limited to as that shown in FIG. 2.

Due to the relatively larger size of the primary display 11 than that of the secondary display 12, the keys of the virtual keyboard could be displayed in a relatively larger size than that of a conventional physical keyboard of the conventional portable device. Accordingly, a user can easily and precisely position fingers on the keys of the virtual keyboard (namely the touch pad 13), so as to enter information.

In response to the user operations on the virtual keyboard (namely the touch pad 13), the processing unit 14 recognizes the operational signals from the touch pad 13, and controls a corresponding display according to the operational signals.

For example, when the operational signals are the editing inputs, that is the operational signals are from the alphanumeric keys, the processing unit 14 changes a state of the secondary display 12 to a power on state, and acts to display information corresponding to the alphanumeric keys on the secondary display 12. Simultaneously, the processing unit 14 does not change the state of the primary display 111 and leaves the state of the primary display 11 in the power off state. Furthermore, when a duration of not receiving operational signals from the alphanumeric keys exceeds a predetermined time period, the processing unit 14 changes the state of the secondary display 12 to the power off state.

When the operational signals are the viewing inputs, that is the operational signals are from the function keys relating to displaying information, the processing unit 14 changes the state of the primary display 11 to the power on state, obtains information from the storage unit 10, and acts to display the information on the primary display 11. Simultaneously, the processing unit 14 does not change the state of the secondary display 12 and leaves the state of the secondary display 2 in the power off state. Furthermore, when a duration of not receiving the operational signals from the function keys relating to displaying information exceeds the predetermined time period, the processing unit 14 acts to redisplay the virtual keyboard on the primary display 11, and then changes the state of the primary display 11 to the power off state.

Therefore, by utilizing the display apparatus 1, the user can easily and precisely enter information on the relatively small secondary display 12 by benefits of the relatively large keys of the virtual keyboard, and can also clearly view information on the relatively large primary display 11. Furthermore, while entering information, the state of the relatively small secondary display 12 is in the power on state, and the state of the primary display is in the power off state, thereby saving power consumption of the portable communication.

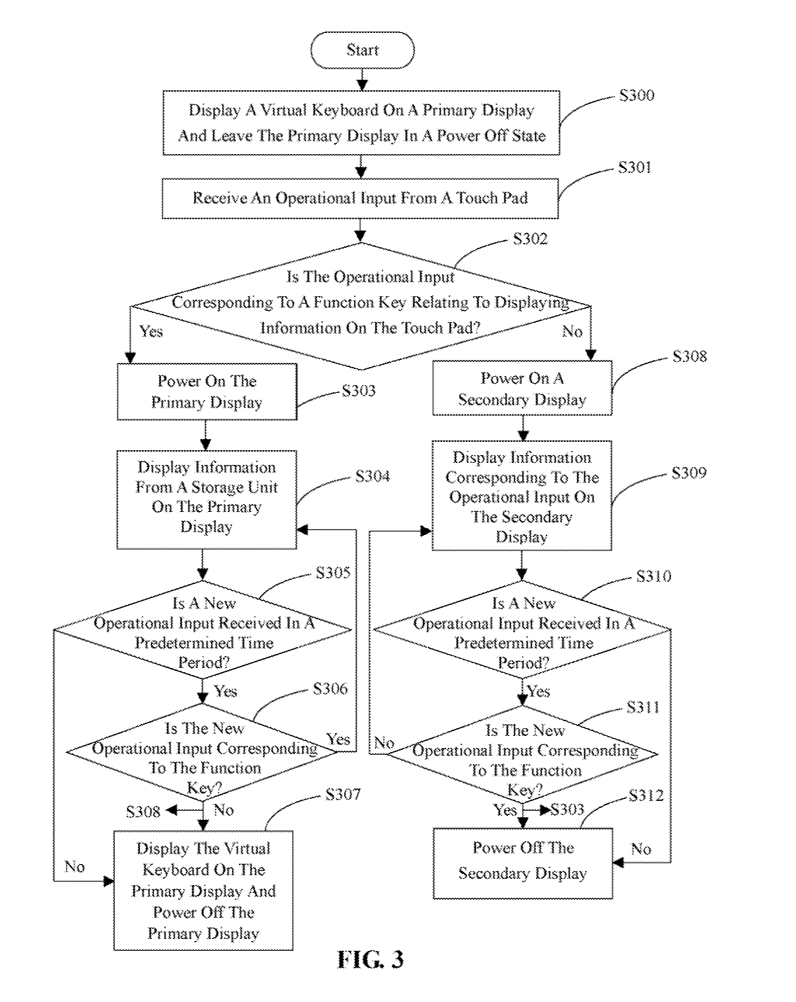

FIG. 3 is a flowchart of a preferred display method of the display apparatus 1 of FIG. 1. In step S300, namely the state of the portable device is the stand-by state, and the state of the primary display 11 and the secondary display 12 are in the power off state, wherein the primary display 11 displays the virtual keyboard thereon.

In step S301, the processing unit 14 receives the operational signal generated from the touch pad 13.

In step S302, the processing unit 14 recognizes the operational signal, that is, the processing unit 14 detects whether the operational signal corresponds to the function key relating to displaying information. If the operational signal does not correspond to the function key relating to displaying information, the procedure goes to step S308 described below.

In step S303, if the operational signal corresponds to the function key relating to displaying information, in step S303, the processing unit changes the state of the primary display 11 to the power on state.

In step S304, the processing unit 14 obtains the information from the storage unit 10, and acts to display the information on the primary display 11.

In step S305, the processing unit 14 detects whether the duration of not receiving any new operational signal exceeds the predetermined time period. If the duration has not exceeded the predetermined time period, the procedure goes to step S307 described below.

If the duration has exceeded the predetermined time period, in step S306, the processing unit 14 detects whether the new operational signal corresponds to the function key relating to displaying information. If the new operational signal corresponds to the function key relating to displaying information, the procedure goes to step S304 described above.

If the new operational signal does not correspond to the function key relating to displaying information, in step S307, the processing unit 14 acts to redisplay the virtual keyboard on the primary display 11 and changes the state of the primary display 11 to the power off state. Simultaneously, the procedure executes step S308.

In step S308, namely where the operational signal corresponds to the alphanumeric key, the processing unit 14 changes the state of the secondary display 12 to the power on state.

In step S309, the processing unit 14 acts to display information corresponding to the alphanumeric key on the secondary display 12.

In step S310, the processing unit 14 detects whether the duration of not receiving any new operational signal exceeds the predetermined time period. If the duration has not exceeded the predetermined time period, the procedure goes to step S312 described below.

If the duration has exceeded the predetermined time period, in step S311, the processing unit 14 detects whether the new operational signal corresponds to the function key relating to displaying information. If the new operational signal does not correspond to the function key relating to displaying information, the procedure goes to step S309 described above.

If the new operational signal corresponds to the function key relating to displaying information, in step S312, the processing unit 14 changes the state of the secondary display 12 to the power off state. Simultaneously, the procedure executes step S303 described above.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A display apparatus adapted for a portable device, comprising:
a storage unit configured for storing information;
a primary display capable of displaying a virtual keyboard in a power off state, wherein the virtual keyboard includes keys for editing information and keys for displaying information;
a secondary display;
a touch pad, positioned on the primary display covering an area of the keys for editing information and an area of the keys for displaying information, structured and arranged for generating an operational signal in response to a touch operation on the virtual keyboard; and
a processing unit, configured for recognizing the operational signal from the touch pad and performing a corresponding control on the primary display and the secondary display;
wherein, when the operational signal is generated in response to a touch operation on the touch pad corresponding to the keys for editing information of the virtual keyboard, the processing unit acts to display information corresponding to the operational signal on the secondary display;
when the operational signal is generated in response to a touch operation on the touch pad corresponding to the keys for displaying information of the virtual keyboard, the processing unit obtains the information stored in the storage unit and acts to display the information on the primary display;
when the processing unit has not received the operational signal for a predetermined time period from the touch pad corresponding to the keys for displaying information of the virtual keyboard, the processing unit acts to display the virtual keyboard on the primary display and acts to power off the primary display.

2. The display apparatus according to claim 1, wherein the primary display and the secondary display are on the same side of the display apparatus.

3. The display apparatus according to claim 1, wherein the primary display is a non-volatile display, and the secondary display is a volatile display.

4. The display apparatus according to claim 3, wherein the primary display is an electronic ink display, and the secondary display is a liquid crystal display.

5. The display apparatus according to claim 4, wherein the primary display is in the power off state, when the secondary display displays the information from the keys for editing information.

6. The display apparatus according to claim 4, wherein the secondary display is in a power off state, when the primary display displays the information from the storage unit.

7. A display method adapted for a portable device, wherein the portable device has a primary display, a secondary display, a touch pad, and a storage unit, the touch pad being positioned on the primary display, the method comprising the steps of:
displaying a virtual keyboard on the primary display when the primary display is in a power off state, wherein the virtual keyboard includes key for editing information, and keys for displaying information;
generating an operational signal in response to a touch operation on the virtual keyboard;
displaying information corresponding to the operational signal on the secondary display, if the operational signal is generated in response to the touch operation on the touch pad corresponding to the keys for editing information of the virtual keyboard;
displaying information stored in the storage unit on the primary display, if the operational signal is generated in response to the touch operation on the touch pad corresponding to the keys for displaying information of the virtual keyboard; and
displaying the virtual keyboard on the primary display and powering off the primary display, if a duration of not receiving the operational signal from the touch pad corresponding to the keys for displaying information exceeds a predetermined time period.

8. The display method according to claim 7, wherein the step of displaying information on the secondary display further comprises the step of: leaving the primary display in the power off state.

9. The display method according to claim 7, wherein the step of displaying information on the primary display further comprises the step of: leaving the secondary display in a power off state.
